(19) United States
(12) Patent Application Publication
(10) Pub. No.: US 2011/0094078 A1
(43) Pub. Date: Apr. 28, 2011

(54) Top side brick removal or extraction tool

(75) Inventors: Kellen J. Wadach, Johnson City, NY (US); Donald G. Hill, Owego, NY (US)

(73) Assignee: LOCKHEED MARTIN CORPORATION

(21) Appl. No.: 11/798,590

(22) Filed: May 15, 2007

(51) Int. Cl. H01R 43/22; H01R 43/26

(52) U.S. Cl. 29/426.5; 29/764

(57) ABSTRACT

A top side brick extraction tool, for removing or extracting DC-DC converter components or bricks from header sockets, or the like, which are soldered onto printed circuit boards or circuit card assemblies, is effectively engaged with or affixed to the top side or upper surface portion of the converter component or brick. In this manner, there is no need to engage the converter component or brick from a side position which would structurally interfere with other electrical components arranged within a relatively dense array upon the printed circuit board or circuit card assembly whereby damage to the header sockets, the solder joints, or other electrical components, mounted upon the printed circuit boards or circuit card assemblies, is effectively prevented.

### STATEMENT OF GOVERNMENT INTERESTS

The United States Government has a paid-up license in connection with the present invention and accordingly has the right in limited circumstances to require the patent owner to license others on reasonable terms as provided for by means of the terms of United States Government Contract Number N00019-04-C-0028 which was awarded by means of the United States Navy.

### FIELD OF THE INVENTION

The present invention relates generally to specialized tools, and more particularly to a new and improved top side brick removal or extraction tool, for removing or extracting DC-DC converter components, or bricks, from header sockets, or the like, which are soldered onto printed circuit boards or circuit card assemblies, wherein the tool is effectively engaged with the top side or upper surface portion of the converter component or brick so as to, in effect, remove or extract the converter component from the header socket in a direction which is substantially perpendicular to the upper surface of the printed circuit board or circuit card assembly, upon which the header socket is soldered, whereby damage to the header sockets, solder joints, or other electrical components, which are conventionally mounted upon the printed circuit boards or circuit card assemblies in a densely packed array, is effectively prevented.

### BACKGROUND OF THE INVENTION

Various electrical components are conventionally mounted upon printed circuit boards or circuit card assemblies in accordance with predeterminedly designed densely packed arrangements or arrays with only a minimal amount of space defined between adjacent components. Accordingly, when it is desired to remove any one of the components, such as, for example, a DC-DC converter component, or brick, from a header socket or the like, which is soldered onto the printed circuit board or circuit card assembly, such a removal process is often difficult to implement or achieve in view of the fact that conventional removal or extraction tools cannot readily be positioned or interposed between the DC-DC converter component, or brick, and neighboring electrical components due to the aforenoted densely packed array of the various electrical components mounted upon the printed circuit boards or circuit card assemblies. In other words, sufficient space is not usually defined, present, or available between the various electrical components in order to permit the particular removal or extraction tool to be properly inserted and manipulated between the adjacent components in order to effectuate the removal or extraction of, for example, a DC-DC converter component, or brick, from the header socket or the like, which is soldered onto the printed circuit board or circuit card assembly. Unless proper tools and techniques are utilized in connection with the removal or extraction of the converter components, or bricks, of the converter components, or bricks, from the socket headers or the like, is likely that the converter components or bricks, the header sockets, the solder joints, or adjacent electrical components, will be damaged.

A need therefore exists in the art for a new and improved specialized tool which can readily, easily, and quickly remove converter components or bricks from header sockets, which are located within densely packed or densely populated areas or regions of printed circuit boards or circuit card assemblies, without risking structural damage to the converter components or bricks, the header sockets, the solder joints, or adjacent electrical components mounted upon the printed circuit board or circuit card assembly.

### SUMMARY OF THE INVENTION

The foregoing and other objectives are achieved in accordance with the teachings and principles of the present invention through the provision of a new and improved specialized tool which comprises a substantially inverted U-shaped support member, a rectangularly configured removal or extraction plate, and an internally threaded manually manipulable hand knob. The substantially inverted U-shaped support member comprises a main support plate which is adapted to effectively be placed over the converter component or brick which is to be removed or extracted from its header socket, and a pair of dependent leg members which are adapted to effectively straddle, or be disposed adjacent to the oppositely disposed end portions of the converter component or brick which is to be removed or extracted from its header socket, and interposed between one or both of the oppositely disposed end portions of the converter component and adjacent electrical components, such that the distal end portions of the dependent leg members can engage or be seated upon the upper surface portion of the circuit card assembly or printed circuit board. The main support plate of the substantially inverted U-shaped support member is provided with three longitudinally spaced apertures, and the rectangularly configured removal or extraction plate is provided with a plurality of through bores which are formed or defined within the peripheral edge regions of the plate and which are adapted to receive threaded bolts which, in turn, are adapted to be threadedly engaged within existing internally threaded bores defined within the converter component or brick so as to effectively fixedly secure the removal or extraction plate to the converter component or brick.

The upper surface portion of the removal or extraction plate is provided with a pair of longitudinally spaced, upstanding guide rods which are adapted to be inserted within the two endmost ones of the three longitudinally spaced apertures defined within the main support plate of the substantially inverted U-shaped support member, and a centrally located upstanding externally threaded rod or stud which is adapted to be inserted through the centrally located one of the three longitudinally spaced apertures defined within the main support plate of the substantially inverted U-shaped support member so as to be capable of threadedly mating with the internally threaded manually manipulable hand knob.

In this manner, once the removal or extraction plate has been fixedly secured to the converter component or brick, and once the substantially inverted U-shaped support member has been disposed over the removal or extraction plate such that the upstanding guide rods and the threaded rod or stud have been inserted through the apertures defined within the main support plate of the substantially inverted U-shaped support member, the internally threaded, manually manipulable hand knob may be threadedly mounted upon the upstanding externally threaded rod or stud. Moreover, as the manually manipulable hand knob continues to be threadedly engaged upon the upstanding externally threaded rod or stud, the removal or extraction plate, which is fixedly attached to the converter component or brick, will effectively be caused to rise, or be elevated, within the interior portion of the substantially inverted U-shaped support member, in a direction which is substantially perpendicular to the upper surface portion of the printed circuit board or circuit card assembly, thereby effectively removing or extracting the converter component or brick from its disposition within the header socket of the printed circuit board or circuit card assembly without interfering with adjacent components which are also secured within the printed circuit board or circuit card assembly.

### BRIEF DESCRIPTION OF THE DRAWINGS

Various other objects, features, and attendant advantages of the present invention will be more fully appreciated from the following detailed description when considered in connection with the accompanying drawings in which like reference characters designate like or corresponding parts throughout the several views, and wherein:

FIG. 1 is a top perspective view of a printed circuit board or circuit card assembly showing a plurality of electrical components, including a plurality of DC-DC converter components or bricks, mounted thereon, wherein it is desired to remove or extract any one of the plurality of DC-DC converter components or bricks from their header sockets by means of the new and improved removal or extraction tool which has been constructed in accordance with the principles and teachings of the present invention;

FIG. 2 is a right end top perspective view of an assembled new and improved removal or extraction tool which has been constructed in accordance with the principles and teachings of the present invention and which shows the cooperative parts thereof;

FIG. 3 is a left end bottom perspective view of the assembled new and improved removal or extraction tool which has been constructed in accordance with the principles and teachings of the present invention and which is disclosed within FIG. 2;

FIG. 4 is a top front perspective view of the assembled new and improved removal or extraction tool which has been constructed in accordance with the principles and teachings of the present invention and which is disclosed within FIGS. 2 and 3;

FIG. 5 is a top front perspective view of the various structural components, shown in an exploded format, comprising the new and improved removal or extraction tool which has been constructed in accordance with the principles and teachings of the present invention and which is also disclosed within FIGS. 2-4;

FIG. 6 is a front elevational view of the substantially inverted U-shaped support member of the new and improved removal or extraction tool as disclosed within FIGS. 2-5;

FIG. 7 is a top plan view of the substantially inverted U-shaped support member of the new and improved removal or extraction tool as disclosed within FIG. 6;

FIG. 8 is a bottom plan view of the substantially inverted U-shaped support member of the new and improved removal or extraction tool as disclosed within FIG. 6;

FIG. 9 is a front elevational view of the removal or extraction plate of the new and improved removal or extraction tool as disclosed within FIGS. 2,3 and 5;

FIG. 10 is a top plan view of the removal or extraction plate of the new and improved removal or extraction tool as disclosed within FIG. 9;

FIG. 11 is a right side top perspective view of the printed circuit board or circuit card assembly as disclosed within FIG. 1 showing, however, the removal or extraction plate fixedly attached to the upper surface portion of one of the DC-DC converter components or bricks which is desired to be removed from its header socket fixedly secured to the printed circuit board or circuit card assembly;

FIG. 12 is front top perspective view of the printed circuit board or circuit card assembly as disclosed within FIG. 11 showing, however, the substantially inverted U-shaped support member having been disposed over the removal or extraction plate, fixedly attached to the DC-DC converter component or brick, such that the upstanding guide rods and centrally located externally threaded rod or stud of the removal or extraction plate project upwardly through the three through-apertures defined within the substantially inverted U-shaped support member; and

FIG. 13 is a right side-end perspective view of the printed circuit board or circuit card assembly as disclosed within FIG. 12 showing, however, the manually manipulable hand knob threadedly mounted upon the upper end portion of the upstanding externally threaded rod or stud of the removal or extraction plate in preparation for commencement of the procedure for removing or extracting the DC-DC converter component or brick from its header socket.

### DETAILED DESCRIPTION OF THE PREFERRED EMBODIMENT

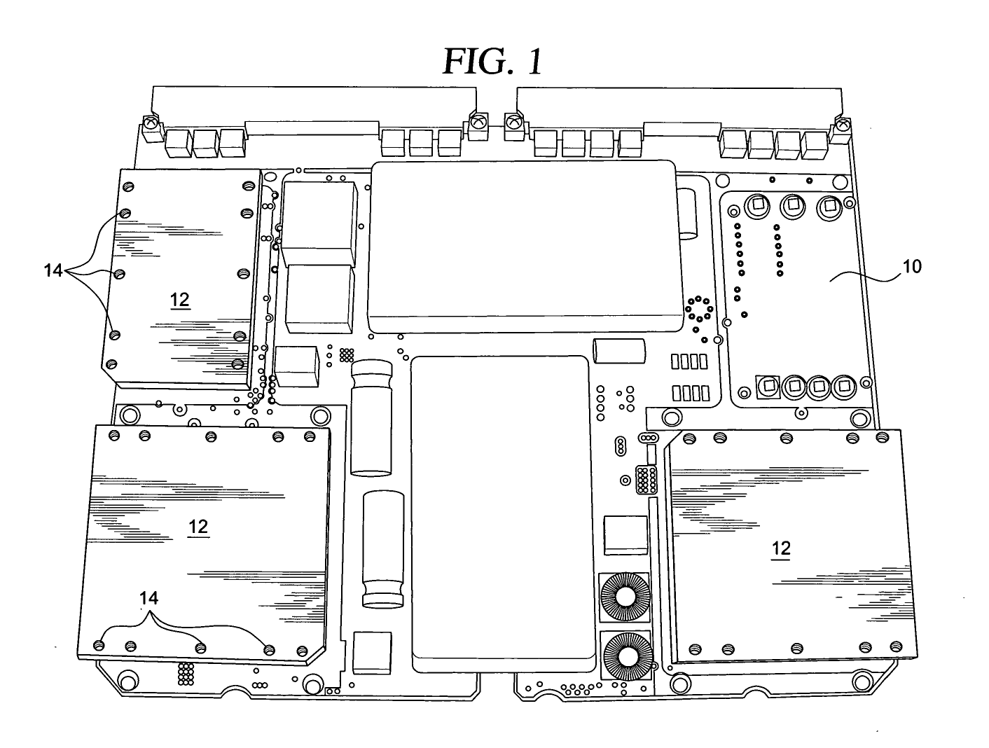

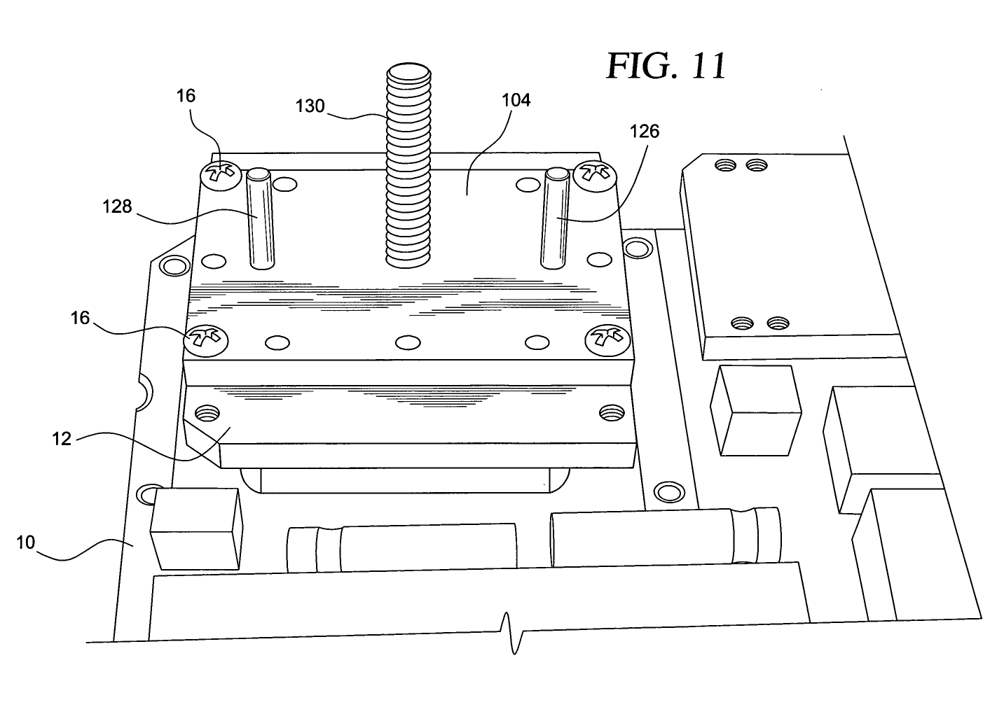

Referring now to the drawings, and more particularly to FIG. 1 thereof, there is disclosed a printed circuit board or circuit card assembly 10 which has a plurality of electrical components, such as, for example, DC-DC converter components, or bricks, 12 which are adapted to be removably mounted within header sockets, not visible, that are fixedly mounted upon the printed circuit board or circuit card assembly 10. The various DC-DC converter components or bricks 12 can have different shapes or dimensions, however, it is seen that, regardless of the particularly sized DC-DC converter component or brick 12, each one of the DC-DC converter components or bricks 12 is provided with a plurality of threaded apertures or bores 14 for respectively receiving one or more threaded fasteners 16, as shown in FIG. 11, which are adapted to secure a cover member, not shown, of a cooling framework which is operatively associated with the printed circuit board or circuit card assembly 10 so as to provide cooling for the various electrical components, including the DC-DC converter components or bricks 12, mounted upon the printed circuit board or circuit card assembly 10. The plurality of threaded apertures or bores 14 are seen to be provided within the DC-DC converter component or brick 12 at positions which are located either within the vicinity of the oppositely disposed end edge portions of the converter component or brick 12 or within the vicinity of the oppositely disposed side edge portions of the converter component or brick 12.

As has been noted hereinbefore, and as can be seen from FIG. 1, the various electrical components, including, for example, the DC-DC converter components or bricks 12, are mounted upon the printed circuit board or circuit card assembly 10 in accordance with predeterminedly designed densely packed arrangements or arrays with only a minimal or limited amount of space being defined between adjacent electrical components. Accordingly, when it is desired to remove any one of the electrical components, such as, for example, one of the DC-DC converter components or bricks 12, from its header socket or the like, which is normally soldered onto the printed circuit board or circuit card assembly 10, such a removal process is often difficult to implement or achieve in view of the fact that conventional removal or extraction tools cannot readily be positioned or interposed between the particular one of the DC-DC converter components or bricks 12 to be removed from the printed circuit board or circuit card assembly 10, and its neighboring or adjacent electrical components, due to the aforenoted densely packed array of the various electrical components as mounted upon the printed circuit board or circuit card assembly 10. In other words, sufficient space is not usually defined, present, or available between the various electrical components disposed upon the printed circuit board or circuit card assembly 10 in order to permit the particular removal or extraction tool to be properly inserted and subsequently manipulated between the adjacent electrical components in order to in fact effectuate the removal or extraction of, for example, one of the DC-DC converter components or bricks 12 from the header socket or the like. Unless proper tools and techniques are utilized in connection with the removal or extraction of the converter components or bricks 12 from the header sockets of the printed circuit board or circuit card assembly 10, damage to the converter components or bricks 12, the header sockets, the solder joints, or adjacent electrical components, will likely occur.

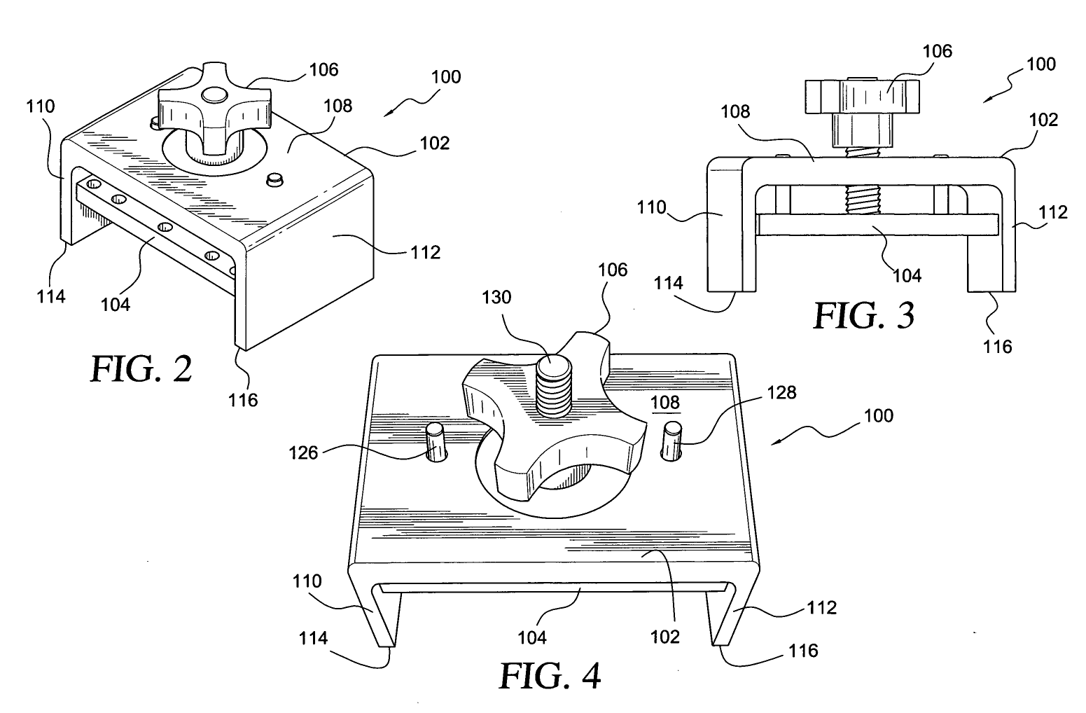

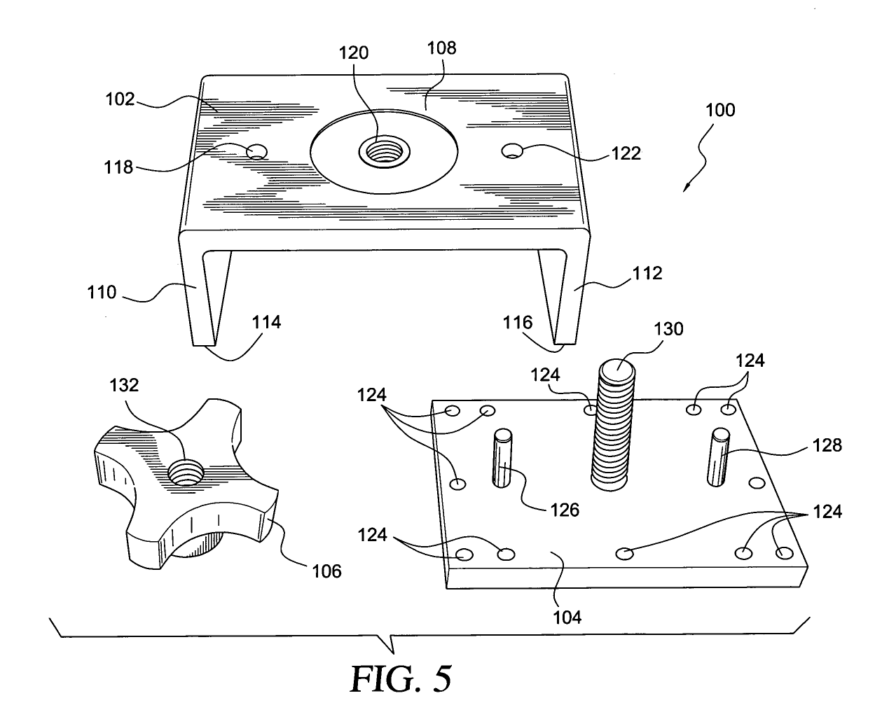

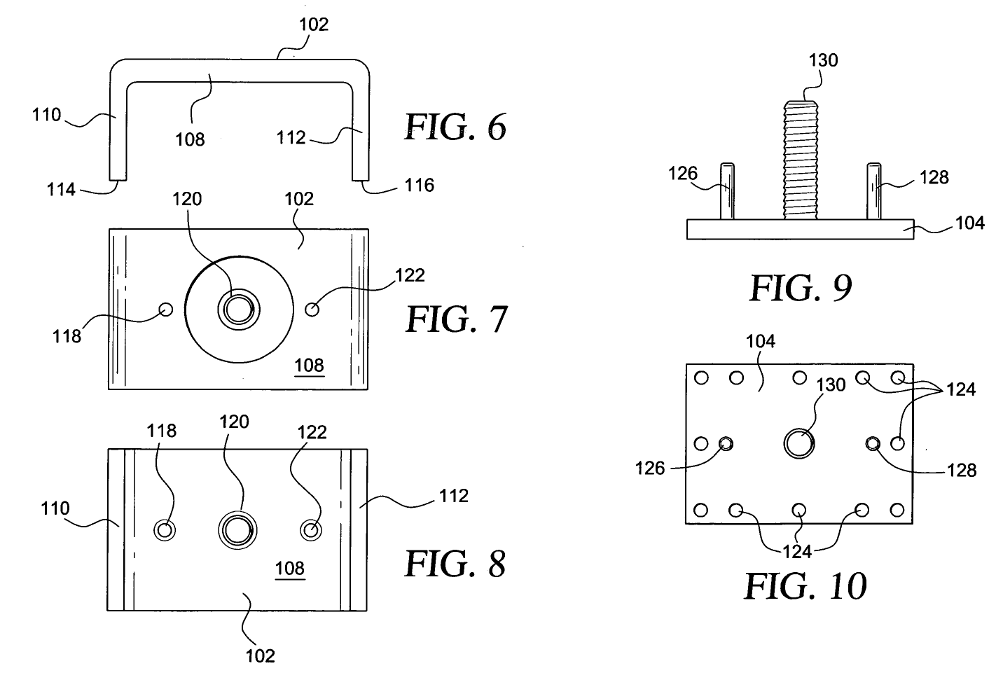

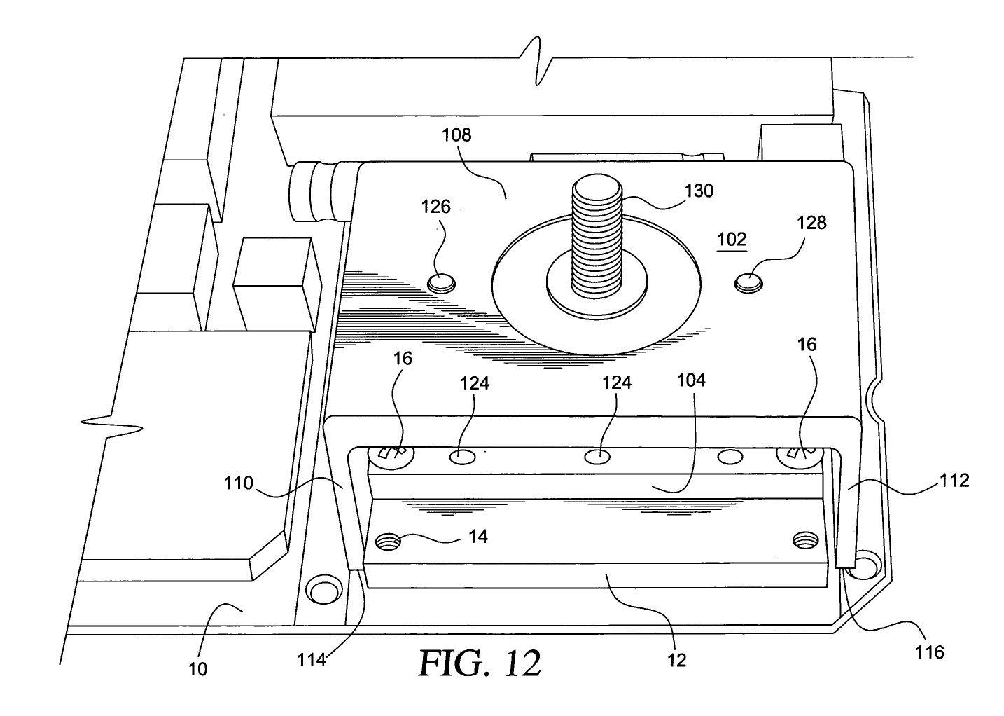

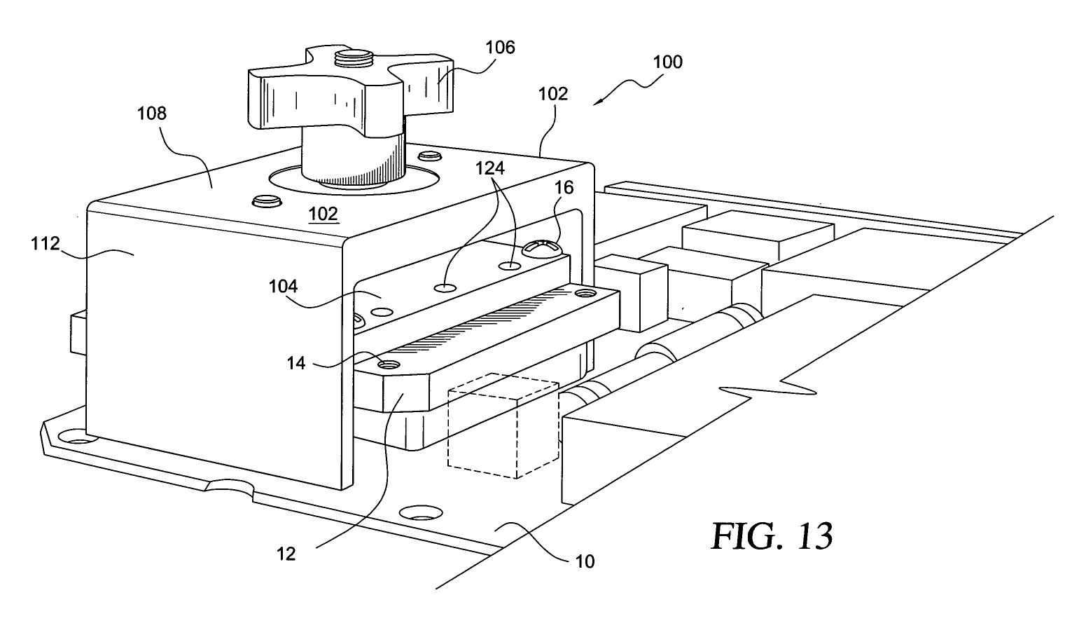

Therefore, there has been developed, in accordance with the principles and teachings of the present invention, a specialized tool for readily, easily, and quickly removing or extracting DC-DC converter components or bricks from their header sockets, which are fixedly mounted upon the printed circuit boards or circuit card assemblies, without endangering or damaging the DC-DC converter components, the header sockets, the solder joints, or adjacent electrical components, wherein the new and improved removal or extraction tool is disclosed within FIGS. 2-13 and is generally indicated by the reference character 100. More particularly, as can best be appreciated from FIG. 5, the new and improved DC-DC converter component or brick removal or extraction tool 100 is seen to comprise three primary operatively interrelated structural components comprising, for example, a support member 102 having a substantially inverted U-shaped cross-sectional configuration, a rectangularly configured removal or extraction plate 104, and an internally threaded nut member or manually manipulable hand knob 106.

The substantially inverted U-shaped support member 102 is seen to comprise a main support plate 108 which has a substantially rectangular configuration, and a pair of longitudinally spaced, oppositely disposed dependent leg members 110,112 which are adapted to effectively straddle the converter component or brick 12, which is desired to be removed or extracted from its header socket fixedly secured upon the printed circuit board or circuit card assembly 10, such that the pair of longitudinally spaced, oppositely disposed dependent leg members 110,112 will be disposed adjacent to the oppositely disposed end portions of the converter component or brick 12 so as to be interposed between such oppositely disposed end portions of the converter component or brick 12 and adjacent electrical components disposed within the densely packed array upon the printed circuit board or circuit card assembly 10. Furthermore, the distal end portions 114,116 of the dependent leg members 110,112 will engage or be seated upon the upper surface portion of the circuit card assembly or printed circuit board 10 when the main support plate 108 is effectively placed over the converter component or brick 12 which is to be removed or extracted from its header socket.

The main support plate 108 of the substantially inverted U-shaped support member 102 is also provided with three longitudinally spaced apertures 118,120,122, with the middle, relatively large one of the three longitudinally spaced apertures being located at the center of the main support plate 108 while the other two, relatively smaller ones of the three longitudinally spaced apertures being defined within the main support plate 108 at positions located between the central aperture 120 and the oppositely disposed ends of the substantially inverted U-shaped support member 102 at which the dependent leg members 110,112 are integrally attached. These three longitudinally spaced apertures 118,120,122 permit the substantially inverted U-shaped support member 102 to be operatively connected to the rectangularly configured removal or extraction plate 104.

More particularly, the rectangularly configured removal or extraction plate 104 is provided with a plurality of through bores 124 which are formed or defined within the removal or extraction plate 104 at locations which are adjacent to the peripheral edge portions of the removal or extraction plate 104, and which are adapted to receive the threaded bolt fasteners 16 which were threadedly engaged within the internally threaded bores or apertures 14 defined within the converter component or brick 12 so as to effectively fixedly secure the removal or extraction plate 104 to the upper or top surface portion of the converter component or brick 12 when the particular converter component or brick 12 is to be removed or extracted from its header socket. It is of course to be appreciated that when it is desired to remove or extract the particular converter component or brick 12 from the printed circuit board or circuit card assembly 10, the cover member, not shown, of the cooling framework, also not shown but provided in conjunction with the printed circuit board or circuit card assembly 10 for cooling the various electrical components thereof, is initially disconnected and removed from the various electrical components as a result of, for example, the removal of the threaded fasteners 16 from, for example, the threaded apertures or bores 14 defined within the converter components or bricks 12, and subsequently, the removal or extraction plate 104 can be fixedly secured to the upper or top surface portion of the particular converter component or brick 12 by inserting the threaded fasteners 16 through the through bores 124 of the removal or extraction plate 104 and threadedly engaging the same within the threaded apertures or bores 14 defined within the particular converter component or brick 12.

It is to be noted that while, for example, twelve apertures 124, for respectively accommodating the threaded fasteners 16, are provided within the removal or extraction plate 104, the removal or extraction plate 104 need not be fixedly secured to the underlying converter component or brick 12 by utilizing all twelve threaded fasteners 16. More particularly, to the contrary, only one pair of the threaded fasteners 16 may be secured, for example, within an oppositely disposed pair of the apertures 124, or alternatively, four threaded fasteners 16, as disclosed within FIG. 11, may be secured, for example, within the four apertures 124 defined within the four corner regions of the removal or extraction plate 104, the underlying principle being the balanced fixation of the removal or extraction plate 104 to the underlying converter component or brick 12 so that when movement of the removal or extraction plate 104 is effectively utilized to remove or extract the converter component or brick 12 from its header socket fixedly mounted within the printed circuit board or circuit card assembly 10, as will be more fully discussed hereinafter, the removal or extraction forces transmitted from the removal or extraction plate 104, to the converter component or brick 12, will effectively be evenly distributed throughout the converter component or brick 12.

Continuing still further, it is also seen that the upper surface portion of the removal or extraction plate 104 is provided with a pair of longitudinally spaced, upstanding guide rods 126,128 which are adapted to be respectively inserted within the two endmost ones 118,122 of the three longitudinally spaced apertures 118,120,122 defined within the main support plate 108 of the substantially inverted U-shaped support member 102. In addition, a centrally located upstanding externally threaded rod or stud 130 is likewise adapted to be inserted through the centrally located one 120 of the three longitudinally spaced apertures 118,120,122 defined within the main support plate 108 of the substantially inverted U-shaped support member 102 so as to be capable of threadedly mating with an internally threaded bore 132 of the manually manipulable hand knob 106. In this manner, as can readily be appreciated, for example, from the assembled views of the new and improved removal or extraction tool 100 of the present invention, as illustrated for example within FIGS. 2-4 and 13, after the removal or extraction plate 104 has been affixedly attached to the upper or top side surface portion of the particular one of the DC-DC converter components or bricks 12, that is desired to be removed or extracted from its header socket fixedly mounted upon the printed circuit board or circuit card assembly 10, by means of the threaded fasteners 16 being inserted through the through-bores 124 of the removal or extraction plate 104 and threadedly engaged within the internally threaded apertures or bores 14 defined within the converter component or brick 12, the substantially inverted U-shaped support member 102 is then positioned over the converter component or brick 12, that is to be removed or extracted, and effectively mated with the removal or extraction plate 104 as a result of the upstanding guide rods 126, 128 of the removal or extraction plate 104 being inserted within and through the apertures 118,122 of the main support plate 108 of the substantially inverted U-shaped support member 102, as well as the upstanding externally threaded rod or stud 130 of the removal or extraction plate 104 being inserted within and through the central aperture 120 of the main support plate 108 of the substantially inverted U-shaped support member 102.

Subsequently, the internally threaded manually manipulable hand knob 106 will be threadedly engaged upon the distal end portion of the externally threaded upstanding rod or stud 130 which is projecting upwardly through the central aperture 120 of the main support plate 108 of the substantially inverted U-shaped support member 102. Subsequently still further, the threaded engagement of the internally threaded manually manipulable hand knob 106 upon the upstanding externally threaded rod or stud 130 is continued until, for example, the lower distal end portions 114,116 of the oppositely disposed leg members 110, 112 of the substantially inverted U-shaped support member 102 are engaged with, and seated upon, the upper surface portion of the printed circuit board or circuit card assembly 10 in a stabilized manner. The actual removal or extraction of the converter component or brick 12, from its header socket fixedly mounted upon the printed circuit board or circuit card assembly 10, is then ready to be implemented.

More particularly, with the lower distal end portions 114,116 of the oppositely disposed leg members 110,112 of the substantially inverted U-shaped support member 102 firmly engaged with, and seated upon, the upper surface portion of the printed circuit board or circuit card assembly 10 in a stabilized manner, it can readily be appreciated that further or progressive threaded engagement or rotation of the internally threaded manually manipulable hand knob 106 upon, and with respect to, the upstanding externally threaded rod or stud 130 of the removal or extraction plate 104 will effectively cause the removal or extraction plate 104, and the converter component or brick 12 to which the removal or extraction plate 104 is fixedly secured by means of the afore-noted fastener connections 16, to be pulled or moved upwardly within the confines of the substantially inverted U-shaped support member 102 as guided by means of the oppositely disposed end edge portions of the removal or extraction plate 104 with respect to the pair of oppositely disposed leg members 110,112, as well as by means of the upstanding guide rods 126,128 of the removal or extraction plate 104 within the apertures 118,122 of the main support plate 108 of the substantially inverted U-shaped support member 102. It is to be additionally noted that the vertical movement of the removal or extraction plate 104, and the converter component or brick 12 fixedly attached thereto, is in a direction that is substantially perpendicular to the upper surface portion of the printed circuit board or circuit card assembly 10, thereby effectively removing or extracting the converter component or brick 12 from its disposition within the printed circuit board or circuit card assembly 10 without any angular or offset motion or movement, without interfering with adjacent components which are also secured with-in the printed circuit board or circuit card assembly 10, and without any damage to the converter component or brick 12, the header sockets, the solder joints, or the adjacent electrical components.

Thus, it may be seen that in accordance with the principles and teachings of the present invention, there has been developed a new and improved top side brick extraction tool, for removing or extracting DC-DC converter components, or bricks, from header sockets, or the like, which are soldered onto printed circuit boards or circuit card assemblies, wherein the tool is effectively engaged with or affixed to the top side or upper surface portion of the converter component or brick. In this manner, the converter component or brick is able to, in effect, be removed or extracted from the header socket in a direction which is substantially perpendicular to the surface of the printed circuit board or circuit card assembly, upon which the header socket is soldered, whereby damage to the header sockets, the solder joints, or other electrical components, which are conventionally mounted upon the printed circuit boards or circuit card assemblies in a densely packed array, is effectively prevented.

Lastly, it is noted that, in light of the foregoing disclosure, many variations and modifications of the present invention are possible. It is therefore to be understood that within the scope of the appended claims, the present invention may be practiced otherwise than as specifically described herein.

What is claimed as new and desired to be protected by Letters Patent of the United States of America, is:

1. A top side electrical component extraction tool for removing an electrical component from a socket defined within a printed circuit board, comprising:
a support member adapted to be seated upon an upper surface portion of a printed circuit board upon which a plurality of electrical components are mounted;
an extraction plate to be fixedly attached to one of the plurality of electrical components which are mounted upon the printed circuit board and which is to be removed from a socket defined within the printed circuit board;
first means defined upon said support member and said extraction plate for movably connecting said extraction plate to said support member; and
second means operatively connected to said extraction plate for causing said extraction plate to move with respect to said support member in order to remove the one of the plurality of electrical components, to which said extraction plate is to be fixedly attached, from the socket defined within the printed circuit board.

2. The extraction tool as set forth in claim 1, wherein:
said support member has a substantially inverted U-shaped cross-sectional configuration.

3. The extraction tool as set forth in claim 2, wherein:
said substantially inverted U-shaped support member comprises a main support plate and a pair of oppositely disposed dependent leg members which are adapted to straddle opposite edge portions of the electrical component to be removed from the printed circuit board, and which are adapted to be seated upon the upper surface portion of the printed circuit board such that said main support plate will be disposed above the electrical component to be removed from the printed circuit board.

4. The extraction tool as set forth in claim 3, wherein said first means defined upon said support member and said extraction plate for movably connecting said extraction plate to said support member comprises:
a plurality of apertures defined within said main support plate of said substantially inverted U-shaped support member; and
a plurality of guide rods fixedly mounted upon said extraction plate and respectively projecting through said plurality of apertures defined within said main support plate of said substantially inverted U-shaped support member for guiding said extraction plate with respect to said substantially inverted U-shaped support member as said extraction plate is moved with respect to said substantially inverted U-shaped support member.

5. The extraction tool as set forth in claim 4, wherein:
an externally threaded rod member is also fixedly attached to said extraction plate and is also adapted to project through one of said plurality of apertures defined within said main support plate of said substantially inverted U-shaped support member; and
said second means, operatively connected to said extraction plate for causing said extraction plate to move with respect to said support member in order to remove the one of the plurality of electrical components, to which said extraction plate is to be fixedly attached, from the socket defined within the printed circuit board, comprises an internally threaded nut member for threadedly engaging said externally threaded rod member, fixedly attached to said extraction plate and projecting through said one of said plurality of apertures defined within said main support plate of said substantially inverted U-shaped support member, such that as said internally threaded nut member is progressively threaded upon said externally threaded rod member, said extraction plate will be caused to move with respect to said support member, thereby removing the electrical component from its socket defined upon the printed circuit board.

6. The extraction tool as set forth in claim 5, wherein:
said internally threaded nut member comprises a manually manipulable hand knob.

7. In combination, top side electrical component extraction tool for removing an electrical component from a socket defined within a printed circuit board, comprising:
a printed circuit board;
a plurality of electrical components mounted upon said printed circuit board;
a support member adapted to be seated upon an upper surface portion of said printed circuit board upon which said plurality of electrical components are mounted;
an extraction plate fixedly attached to one of said plurality of electrical components which is removably mounted upon said printed circuit board and which is to be removed from a socket defined within said printed circuit board;
first means defined upon said support member and said extraction plate for movably connecting said extraction plate to said support member; and
second means operatively connected to said extraction plate for causing said extraction plate to move with respect to said support member in order to remove said one of said plurality of electrical components, to which said extraction plate is fixedly attached, from the socket defined within the printed circuit board.

8. The combination as set forth in claim 7, wherein:
said one of said plurality of electrical components which is to be removed from the socket defined within said printed circuit board comprises a DC-DC converter component.

9. The combination as set forth in claim 8, further comprising:
a plurality of threaded bores defined within said DC-DC converter component; and
a plurality of threaded fasteners are threadedly engaged within said plurality of threaded bores defined within said DC-DC converter component so as to fixedly attach said extraction plate to said DC-DC converter component.

10. The combination as set forth in claim 7, wherein:
said plurality of threaded fasteners are threadedly engaged within said plurality of threaded bores defined within said DC-DC converter component in accordance with a predetermined array so as to distribute the extraction forces from said extraction plate to said DC-DC converter component in a balanced manner.

11. The combination as set forth in claim 7, wherein:
said support member has a substantially inverted U-shaped cross-sectional configuration.

12. The combination as set forth in claim 11, wherein:
said substantially inverted U-shaped support member comprises a main support plate and a pair of oppositely disposed dependent leg members which are adapted to straddle opposite edge portions of said one of said plurality of electrical components which is to be removed from said printed circuit board, and which are adapted to be seated upon said upper surface portion of said printed circuit board such that said main support plate will be disposed above said one of said plurality of electrical components which is to be removed from said printed circuit board.

13. The combination as set forth in claim 12, wherein said first means defined upon said support member and said extraction plate for movably connecting said extraction plate to said support member comprises:
a plurality of apertures defined within said main support plate of said substantially inverted U-shaped support member; and
a plurality of guide rods fixedly mounted upon said extraction plate and respectively projecting through said plurality of apertures defined within said main support plate of said substantially inverted U-shaped support member for guiding said extraction plate with respect to said substantially inverted U-shaped support member as said extraction plate is moved with respect to said substantially inverted U-shaped support member.

14. The combination as set forth in claim 13, wherein:
an externally threaded rod member is also fixedly attached to said extraction plate and is also adapted to project through one of said plurality of apertures defined within said main support plate of said substantially inverted U-shaped support member; and
said second means, operatively connected to said extraction plate for causing said extraction plate to move with respect to said support member in order to remove said one of said plurality of electrical components, to which said extraction plate is fixedly attached, from the socket defined within said printed circuit board, comprises an internally threaded nut member for threadedly engaging said externally threaded rod member, fixedly attached to said extraction plate and projecting through said one of said plurality of apertures defined within said main support plate of said substantially inverted U-shaped support member, such that as said internally threaded nut member is progressively threaded upon said externally threaded rod member, said extraction plate will be caused to move with respect to said support member, thereby removing said one of said plurality of electrical components from said socket defined upon said printed circuit board.

15. The combination as set forth in claim 14, wherein:
said internally threaded nut member comprises a manually manipulable hand knob.

16. A method of removing an electrical component from a printed circuit board having a plurality of electrical components mounted thereon, comprising the steps of:
fixedly attaching an extraction plate to one of said plurality of electrical components which is removably mounted upon said printed circuit board and which is to be removed from a socket defined within said printed circuit board;
positioning a support member over said extraction plate, attached to said one of said plurality of electrical components which is to be removed from said printed circuit board, such that said support member is seated upon an upper surface portion of said printed circuit board while said extraction plate is movably connected to said support member; and
moving said extraction plate with respect to said support member so as to remove said one of said plurality of electrical components, to which said extraction plate is fixedly attached, from the socket defined within said printed circuit board.

17. The method as set forth in claim 16, further comprising the steps of:
providing a plurality of threaded bores defined within said one of said plurality of electrical components; and
threadedly engaging a plurality of threaded fasteners within said plurality of threaded bores defined within said one of said plurality of electrical components so as to fixedly attach said extraction plate to said one of said plurality of electrical components.

18. The method as set forth in claim 17, further comprising the step of:
threadedly engaging said plurality of threaded fasteners within said plurality of threaded bores defined within said one of said plurality of electrical components in accordance with a predetermined array so as to distribute the extraction forces from said extraction plate to said one of said plurality of electrical components in a balanced manner.

19. The method as set forth in claim 17, further comprising the steps of:
providing said support member with a substantially inverted U-shaped cross-sectional configuration comprising a main support plate and a pair of oppositely disposed dependent leg members which are adapted to straddle opposite edge portions of said one of said plurality of electrical components which is to be removed from said printed circuit board, and which are adapted to be seated upon said upper surface portion of said printed circuit board such that said main support plate is disposed above said one of said plurality of electrical components which is to be removed from said printed circuit board;
providing a plurality of apertures within said main support plate of said substantially inverted U-shaped support member; and
respectively projecting a plurality of guide rods, fixedly mounted upon said extraction plate, through said plurality of apertures defined within said main support plate of said substantially inverted U-shaped support member so as to guide the movement of said extraction plate with respect to said substantially inverted U-shaped support member as said extraction plate is moved with respect to said substantially inverted U-shaped support member so as to remove said one of said plurality of electrical components, to which said extraction plate is fixedly attached, from the socket defined within said printed circuit board.

20. The method as set forth in claim 19, further comprising the steps of:
fixedly attaching an externally threaded rod member to said extraction plate so as to project through one of said plurality of apertures defined within said main support plate of said substantially inverted U-shaped support member; and
threadedly engaging an internally threaded nut member upon said externally threaded rod member so as to cause said extraction plate to move with respect to said support member, and thereby remove said one of said plurality of electrical components from the socket defined within said printed circuit board, as said internally threaded nut member is progressively threaded upon said externally threaded rod member.
